(19) United States
(12) Patent Application Publication
(10) Pub. No.: US 2020/0372642 A1
(43) Pub. Date: Nov. 26, 2020

(54) POSITIONAL BIOMARKERS BASED ON BRAIN IMAGING

(71) Applicant: MUSC Foundation for Research Development, Charleston, SC (US)

(72) Inventors: Davud Asemani, Charleston, SC (US); Donna Roberts, Charleston, SC (US)

(21) Appl. No.: 16/880,409

(22) Filed: May 21, 2020

Related U.S. Application Data
(60) Provisional application No. 62/850,734, filed on May 21, 2019.

(51) Int. Cl. G06T 7/00; G06T 7/70; G06T 7/62; G06T 7/37; G06T 3/00; G06T 3/60

(52) U.S. Cl. CPC G06T 7/0012; G06T 7/70; G06T 7/62; G06T 2207/10088; G06T 3/0006; G06T 3/608; G06T 2207/30016; G06T 7/37

(57) ABSTRACT

Methods and systems for skull-based brain imaging. In some examples, a method includes receiving a first brain image of a brain taken at a first time and a second brain image of the brain taken at a second time; characterizing a structural change of brain tissue of the brain between the first time and the second time by: determining a global linear change of brain tissue using the first brain image and the second brain image; and determining a local deformation of brain tissue using the first brain image, the second brain image, and the global linear change of brain tissue; and outputting one or more parameters characterizing the structural change based on the global linear change of brain tissue and the local deformation of brain tissue.

### PRIORITY CLAIM

This application claims the benefit of U.S. Provisional Application Ser. No. 62/850,734, filed May 21, 2019, the disclosure of which is incorporated herein by reference in its entirety.

### STATEMENT OF GOVERNMENT INTEREST

This invention was made with government support under grant NNX13AJ92G awarded by the National Aeronautics and Space Administration (NASA). The government has certain rights in the invention.

### TECHNICAL FIELD

This specification relates generally to medical brain imaging and in particular to brain MRI scans reading and diagnosis.

### BACKGROUND

The quantitative analysis of structural magnetic resonance imaging (MRI) has the potential to measure physiologically or clinically relevant parameters like brain volume loss (BVL) or atrophy as biomarkers of disease progression in various pathologies such as multiple sclerosis (MS) and Alzheimer's Disease (AD) [1-5]. However, there are limitations to the use of imaging biomarkers derived from MRI data because they can be affected by various confounds and errors due to, among others, motion during image acquisition [6], hydration levels [7-9], rehydration versus actual regrowth [10], variation in head size [11], and scanner calibration and hardware drift [12], which can influence biomarker sensitivity and specificity. In addition, the sensitivity of biomarkers can be limited by systematic errors that add up during the analysis steps, such as identifying brain from non-brain tissues (i.e. skull stripping or brain extraction), interpolation, and tissue-type segmentation for white mater (WM), grey mater (GM) and cerebrospinal fluid (CSF).

### SUMMARY

This specification describes methods and systems for skull-based reading of brain imaging. In some examples, a method includes receiving a first brain image of a brain taken at a first time and a second brain image of the brain taken at a second time; characterizing a structural change of brain tissue of the brain between the first time and the second time by: determining a global linear change of brain tissue using the first brain image and the second brain image; and determining a local deformation of brain tissue using the first brain image, the second brain image, and the global linear change of brain tissue; and outputting one or more parameters characterizing the structural change based on the global linear change of brain tissue and the local deformation of brain tissue.

The computer systems described in this specification may be implemented in hardware, software, firmware, or any combination thereof. In some examples, the computer systems may be implemented using a computer readable medium having stored thereon computer executable instructions that when executed by the processor of a computer control the computer to perform steps. Examples of suitable computer readable media include non-transitory computer readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

FIG. 1 shows a schematic representation of a method for estimating global linear change. G_{A2B} and G^{MNI}_{A2B} represent the global changes in the native and common MNI spaces respectively.

FIG. 2 is a plot illustrating the range of morphological errors [%] along XYZ axes caused by pair registration of widely-used FSL package (PR) on the synthetic data comprising of shifted versions of MNI brain template. XYZ corresponds to the radiological RAS coordination.

FIG. 3 shows the error [%] in the PBVC estimated by FSL-SIENA on MNI template brains undergoing shifts [mm] at different directions: posterior-to-anterior (Y), inferior-to-superior (Z), or both (YZ).

FIG. 4 illustrates pair registration error due to widely-used FSL-SIENA package: regression (blue) and extension (red) in the edge flow image overlayed on the MNI brain template. The post-brain was the same as the pre-brain template except for a shift posteriorly by 5 mm.

FIG. 5 is a graph illustrating global changes in the brain based on the proposed algorithm for the HTBR (right) cohort compared with the normal aging group (left). XYZ determines the orientation according to the radiological RAS system and * identifies the significant changes. Error bars show 95% CI.

FIG. 6 shows two graphs illustrating mean PBVC (top) and PVVC (bottom) results for the HTBR and normative aging groups using different algorithms: total change by conventional FSL-SIENA (PR), and proposed method (SB). Total change value of SB method is constituted of the global and local change components. Error bars show 95% CI.

FIG. 7 shows the significant edge displacement [mm] for the HTBR group using the conventional PR method adjusted for the time duration of bed rest experiment. The regression (atrophy) and extension (growth) of the brain in mm are shown. The proposed SB method came up with no voxel showing significant change in this analysis. CorrP represents the corrected p-value.

FIG. 8 shows significant edge displacement [mm] for the healthy aging group using the conventional PR (left) and the proposed SB (right) methods (in the radiological coordinate). The regression (atrophy) and extension (growth) of the brain in mm are shown.

FIG. 9 is a block diagram of an example system for determining changes in brain structure from brain images.

### DETAILED DESCRIPTION

This specification describes methods and systems for skull-based brain imaging. The methods and systems are described below with reference to a study that illustrates representative, non-limiting examples of the methods and systems.

To estimate total brain volumetric changes, the skull-constrained pair registration (PR) algorithm, integrated in the FMRIB software library (FSL), has been used for many longitudinal and cross-sectional studies of structural brain changes. We present mathematical and experimental evidence that PR-based results are prone to error, specifically for the detection of voxel-wise structural changes, when the brain has undergone a shift or rotation within the calvarium between two scans. Instead, we propose an alternative skull-based (SB) algorithm to accurately calculate not only any shift/rotation on the whole brain, but also voxel-wise structural changes in the brain. In addition, we propose two new volumetric markers, global linear and local deformations, which constitute the total brain volume change. These two volumetric markers can intuitively discriminate brain structural changes between different groups. In this paper, the performance of the conventional PR and proposed SB methods are evaluated using two longitudinal MRI datasets: eight (5 male) healthy volunteers who underwent −6° head-down tilt bed-rest (HTBR) experimentation for 53.5±7.5 days and 24 healthy volunteers (5 male) for studying healthy aging over 2.8±1.5 years.

The results show significant global structural changes happen in both groups including: a shift of brain in posterior (−0.2 mm, p=0.02) and inferior (−0.26 mm, p<0.001) directions along with a rotation around left-to-right axis (−0.22°, p=0.01) and uniform compression over all three axes (average −0.5%, p<0.02) in normative aging group; compared with a right-to-left shift (−0.18 mm, p=0.02) and rotation around the left-to-right axis (−0.25°, p=0.01) and compression in transverse plane (−0.8%, p=0.01) in the HTBR group. The average estimated percentage brain volume change (PBVC) and ventricular volume change (PVVC) are (−0.59%, +2.58%) and (−0.44%, +2.68%) respectively for the PR and SB methods in the normal aging group. Both the PR and SB methods show no significant PBVC and PVVC in the HTBR group. However, the proposed method describes significant local (+2.6%, p=0.01) and global (−1.89%, p=0.02) components of PBVC in the HTBR group. We hypothesize that the global shrinkage of brain stems from the CSF hydrodynamics. In addition, the brain atrophy over the normative aging is due to global shrinkage which is not compensated for by local extension. In voxel-wise analysis after adjusting for the time interval between scans, the proposed SB method is clearly contrasted from the conventional PR method. The SB method localizes no significant regional atrophy or extension in the HTBR group. Considering the normal aging group, the proposed SB method predicts a regression or atrophy on the superior portion of the brain around vertex. The atrophy regression is also spotted on the superior thalamus, inferior to the ventricular system. An extension or edema is also localized at the inferior left temporal and frontal lobes. Lastly, the proposed global and local volumetric change parameters have potential to develop more efficient biomarkers for brain disorders.

### 1. INTRODUCTION

The quantitative analysis of structural magnetic resonance imaging (MRI) has the potential to measure physiologically or clinically relevant parameters like brain volume loss (BVL) or atrophy as biomarkers of disease progression in various pathologies such as multiple sclerosis (MS) and Alzheimer's Disease (AD) [1-5]. However, there are limitations to the use of imaging biomarkers derived from MRI data because they can be affected by various confounds and errors due to, among others, motion during image acquisition [6], hydration levels [7-9], rehydration versus actual regrowth [10], variation in head size [11], and scanner calibration and hardware drift [12], which can influence biomarker sensitivity and specificity. In addition, the sensitivity of biomarkers can be limited by systematic errors that add up during the analysis steps, such as identifying brain from non-brain tissues (i.e. skull stripping or brain extraction), interpolation, and tissue-type segmentation for white mater (WM), grey mater (GM) and cerebrospinal fluid (CSF).

The brain can shift and rotate within the skull along with morphological deformation. The brain is a soft tissue that can shift, rotate, and/or become deformed over time compared to the fixed skull. This means that the skull can be considered as an important reference tissue in either longitudinal or cross-sectional studies, to the extent that boney tissue exhibits limited longitudinal change relative to soft tissue changes during the period of a study. The CSF pressure gradient across the subarachnoid space and the ventricular system is related with the positioning and morphology of brain such that brain features deform in response to alterations in the CSF pressure and volume [13]. The equilibrium of the CSF hydrodynamics depends on factors such as CSF production rate, outgoing pressure at dural venous sinuses, and CSF pressure pulsation [14-17]. Any change in this hydrodynamic equilibrium state may represent a change in the intracranial position of brain that can lead to a shift, rotation or deformation of cerebrum. Intracranial brain shift and deformation have been reported following, among others, head trauma, subdural hematoma, occlusion of the bridging veins, venous infarcts and malignant middle cerebral artery (MCA) territory infarction [11, 19, 24, 25]. Temporary cortical shift amplitudes have been reported to be within (−7.86 mm, +5.71 mm) and (−11.46 mm, +7.30 mm) ranges for head movement in the sagittal and coronal planes respectively [26]. The brain-skull motion plays a pivotal role in the etiology of traumatic brain injury (TBI) [26].

An intracranial brain shift and deformation in healthy subjects following a long-term mission aboard the international space station (ISS) has been reported [31]. This finding was validated by three experienced neuro-radiologists who evaluated the MRI scans by radiographic readings [31]. This structural change is typically different from the abovementioned brain shift phenomena because this change: 1) represents a global shift and stretching distortion that can be described by a linear affine transformation across entire brain; 2) occurred chronically in healthy subjects following a long-term exposure to microgravity (about 6 months) in absence of any neurosurgery procedure, TBI, hemorrhage, or concussion. Though it was reported for a group of ISS astronauts, we hypothesize that this global change in brain structure can occur in other conditions where there is a change in tissue volume (e.g., normal aging or Alzheimer's disease). Characterizing these changes is important clinically, but also has methodologic relevance because they could affect conventional analysis methods leading to inaccurate results, as shown below. In this specification, we will present and implement a technical method for measuring the changes in the intracranial position of brain with reference to the skull.

Brain changes can be divided into global and local structural changes. In this specification, we propose to decompose the volumetric change of brain tissue into global linear change and local deformation as well. Total brain volumetric change can be obtained by summing up the global and local volumetric changes. The proposed components of global and local volumetric changes in the brain may be used as powerful markers rather than single total volumetric change (common in the literature) to identify longitudinal brain changes due to different conditions such as aging and AD. Two time points (pre- and post-disease or any environmental change) are used to characterize global changes in brain tissue that are represented by an affine transformation matrix with 12 degrees of freedom (DOF12) based on registration of the image from the first time point to the image collected at the second time point. Thus, global changes can be defined by shifting, rotation, stretching (scaling) and skewing over 3 axes. The skull segment is required as the reference tissue for estimating global changes. Local deformation was used to characterize any local extension-regression necessary to accurately overlay the affine-registered images. The extension-regression changes can represent either focal growth-atrophy, edema, or simple local displacement at any voxel across the cerebral parenchyma.

Conventional neuroimaging tools mostly assess for local morphological changes. There is no consensus about how or when global and local morphologic changes should be characterized in longitudinal studies. A number of registration-based automated methods have been designed for estimating progressive brain atrophy [32], such as voxel-based morphometry (VBM) and deformation-based morphometry (DBM). These methods assess only for local morphological changes because an affine registration of brains is implemented prior to the change analysis. So, those methods do not use the skull tissue in their processing steps. There are other methods that address both global and local changes together such as boundary shift integral (BSI) [5, 33], and FMRIB Software Library (FSL) packages including SIENA (Structural Image Evaluation, using Normalization of Atrophy) [34, 35] for longitudinal measurement, and SIENAX [35] for cross-sectional measurement. Three popular tools for measuring brain atrophy are BSI, SIENA (atrophy rate) and SIENAX (atrophy state). BSI and SIENA were shown to have similar accuracy with around 0.2% error in estimating the percentage brain volume change (PBVC) [3]; whereas SIENA exhibited a better accuracy than VBM with around 1.03% mean differences in estimating PBVC between two methods [36, 37]. SIENA has widely been used in longitudinal studies of neurological disorders and mental illnesses, such as AD and dementia [38, 39], MS [40, 41] and in normal aging [37, 42].

To analyze and evaluate total (global and local) changes in the brain volume, we consider the FSL-SIENA method in this specification. We will show that previously-used tools (e.g., SIENA) lead to inaccurate volumetric change (or edge flow images) since brain shift and rotation are disregarded through the related skull-constrained registration. Instead, we will propose a new skull-based analysis that can provide with more accurate results by considering the intracranial positioning of brain.

In this specification, we describe a pipeline to first calculate the global brain changes in longitudinal studies. Then, we will mathematically show that conventional tools (e.g. SIENA) lead to inaccurate edge flow images since brain shift and rotation are disregarded through the related skull-constrained registration. We will propose a new pipeline to estimate the changes in brain more accurately. Then, we will estimate the global and local brain changes which can alternatively represent the changes in brain rather than total volume change. In this study, we will use three sets of neuroimaging data: 1) a synthetic MRI data bank that we made from the Montreal Neurological Institute (MNI152) brain template, 2) T1-W MRI images from a healthy normal cohort to study healthy aging, and 3) T1-W MRI images from eight volunteers who underwent −6° head-down tilt bed rest (HTBR) experimentation between two scans. HTBR is used as a model for studying the physiological changes occurring in weightlessness during spaceflight [31], [43, 44], [45], [46].

### 2. METHODS AND DATA

2.1 Proposed Skull-Based Algorithm

In the proposed methodology, referred by the skull-based (SB) algorithm, two structural MR images, taken at different points in time, are considered as input. Total structural change of brain tissue, from the first time point (Pre or A) to the second time point (Post or B), is decomposed into: 1) global linear change and 2) local deformation. The superposition of these two components results in the total brain change. For convenience, the global linear change is here estimated at the native spaces rather than the half-way space between two images for each subject. However, the local change is calculated based on the half-way space to suppress the interpolation errors. The proposed pipeline calculates the change components as follows:

Global Linear Change:

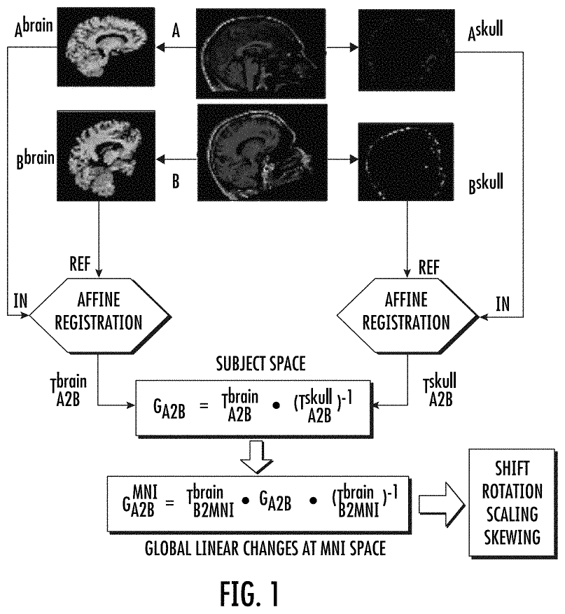

Global linear change is represented with an affine transformation matrix by which the brains at two time points can linearly be aligned together. It is global because the same linear transformation matrix is applied to every voxel across the entire brain. The overall procedure of estimating the global linear change has been shown in FIG. 1. Following brain extraction by the skull stripping of both MR images, the initial step is to register Pre-skull (A^{skull}) to Post-skull (B^{skull}) using an affine registration that gives the transformation matrix of T^{skull/A2B}(see FIG. 1). This initial step compensates for any geometrical differences between Pre and Post images due to head positioning in the MRI scanner. In parallel, the Pre-brain (A^{brain}) is affine registered to the Post-brain (B^{brain}) to obtain the transformation matrix of T^{brain/A2B}. The global change from Pre-brain to Post-brain is now described by a linear affine transformation matrix (G_{A2B}) that holds: B^{brain}=G_{A2B} (T^{skull/A2B}*A^{brain})=T^{brain/A2B}*A^{brain}. So, this leads to:

G_{A2B}=T_{A2B}^{brain}·(T_{A2B}^{skull})⁻¹ (1)

G_{A2B} describes the global changes at the native space (where B^{brain} and B^{skull} exist). In other words, it shows that Pre-brain (A^{brain}) undertakes a global change for aligning with Post-brain (B^{brain}) including shift (mm), rotation (degree), stretching (%) and skewing (%) over three axes (see FIG. 1). To evaluate and analyze across a group, the global changes must be represented in a common coordinate space, such as MNI standard space. To begin with, both skull-aligned Pre-brain (A^{brain/1}=T^{skull/A2B}*A^{brain}) and Post-brain (B^{brain}) are registered (rigid body transformation with 6 degrees of freedom) to the MNI standard brain template as A₁_{_{MNIwrtB}}^{brain}=T_{B2MNI}^{brain}·A₁^{brain} and B_{MNI}^{brain}=T_{B2MNI}^{brain}·B^{brain}. Now, the global change matrix can be mapped to the MNI space as follows:

B_{MNI}^{brain}=G_{A2B}^{MNI}·A₁_{_{MNIwrtB}}^{brain} (2)

where G_{A2B}^{MNI} represents the global change at the standard MNI space. T_{B2MNI}^{brain} stands for the rigid body transformation matrix from Post-brain to MNI brain template. Employing the previous relationships, we can calculate the global change at the standard MNI space (G_{A2B}^{MNI}) as following:

G_{A2B}^{MNI}=T_{B2MNI}^{brain}·G_{A2B}·(T_{B2MNI}^{brain})⁻¹ (3)

Local Change: For calculating local change, we exploit the same method as used in FSLSIENA for obtaining the edge flow image [4, 34, 35] except for using T^{brain/A2B} (direct linear registration of Pre-brain onto Post-brain) instead of the skull-constrained pair registration implemented by PAIRREG algorithm in FSL-SIENA [4, 34, 35]. This flow image will show every local edge displacement between the Pre and Post time points. By local change analysis, the aim is to calculate only local deformations as a flow image given that the global change component has already been assessed for by G_{A2B}. The analysis of voxel-wise results of this method is difficult because they are representing only a part of total brain changes. However, we will use the non-voxel-wise local volumetric change (i.e., integrating local changes across the entire brain) as a parameter which is complementary to the parameter of global brain changes. Total volumetric change in brain can be calculated by using the global and local volumetric change parameters.

Total Change: The total change in brain includes both global linear and local brain changes. FSL-SIENA and BSI are the tools that attempt to estimate total brain changes. In our proposed method, the total brain changes on voxel resolution are directly calculated by the same method explained in the local change analysis except for using G_{A2B}^{rigid}·T_{A2B}^{skull} instead of the skull-constrained pair registration implemented by PAIRREG algorithm in FSL-SIENA [4, 34, 35]. T_{A2B}^{skull} accounts for the skull alignment. G_{A2B}^{rigid} is the rigid body transformation part of G_{A2B} defined in (1). The total volumetric change demonstrates the superposition of global and local volumetric changes as well. The total changes in the brain is exactly what the FSL-SIENA algorithm attempts to estimate. In this paper, we analyze the MRI data to compare our proposed new approach with the skull-constrained pair registration (FSL-PAIRREG) employed in SINEA/SIENAX. We will show that the latter can be affected by a global shift or rotation in the brain positioning.

2.2 Revisiting Skull-Constrained Pair Registration in FSL

FSL-SIENA and SIENAX use the PAIRREG script to register pairs of MRI scans from the same subject by keeping the skull scaling constant [34, 35]. This script uses a special optimization schedule to register two brain images, while at the same time using two skull images to hold the scaling constant (in case the brain has shrunk over time, or the scanner calibration has changed). For this purpose, the brains are first registered to one another as fully as possible. This registration is then applied to the skull images, but only the scaling and skew are allowed to change. This is then applied to the brain images, and a final pass optimally rotates and translates the brains to get the best final registration. In summary, this skull-constrained registration results in an affine transformation (T₁₂^{PR}) in which shifting and rotation (T₆^{Shift-Rot}) with 6 parameters, are obtained from the registration of brains, and the remaining six parameters (T₆^{Scale-Skew}) due to scaling and skewing, from the registration of skulls. Their efficient script is accurate as long as there is neither shifting nor rotating changes between the brains. Otherwise, the registration is not perfect.

Mathematical Demonstration: We can mathematically demonstrate that the pair-registration method (PR), used in SIENA and SIENAX, can lead to inaccurate results if a rotation or shift change has happened in the brains from first to second time point. As a simple example, suppose that the Post-brain B^{brain}(x, y, z) is the same as the Pre-brain A^{brain}(x, y, z), except for a superior shift of z₀, i.e. B^{brain}(x, y, z)=A^{brain}(X, y, z−z₀). Then, the Post-skull B^{skull}(x, y, z) and Pre-skull=A^{skull}(x, y, z) are exactly the same and then completely aligned (i.e., with an identity matrix), which gives B^{skull}(x, y, z)=A^{skull}(x, y, z). The PAIRREG script will initially shift the Pre-skull superiorly by z₀ as a result of the brain registration step leading to A^{skull}(x, y, z−z₀). Next, this script will have to distort the shifted Pre-skull A^{skull/1}(X, y, z−z₀) by scaling and skewing factors so as to compensate for this superior shift. Thus, to precisely overlay shifted Pre-skull A^{skull/1}(x, y, z−z₀) on the Post-skull B^{skull}(x, y, z), it leads to:

$${T}_{6}^{scale \text{-} Skew} = {arg}_{{T}_{6}} Min ‖ {B}^{skull} ( x , y , z ) - {T}_{6}^{scale \text{-} Skew} \cdot {A}^{skull} ( x , y , z - {z}_{0} ) ‖ \qquad ( 4 )$$

Finally, the PAIRREG script will result in a transformation (i.e., concatenation of T₆^{Shift-Rot}=T_{shift:z0} with non-identity transformation of T₆^{Scale-Skew}) that causes undesired distortions across the Pre-brain through a non-identity matrix as T₆^{Scale-Skew}. SIENAX calculates a v-scaling factor to normalize the brain volumes so that they are comparable in the standard stereotaxic space. This scaling is the determinant of the skull constrained pair registration matrix that registers the subject MRI onto the standard template. The deformation error caused by PAIRREG script directly results in erroneous v-scaling factors for SIENAX volume analysis. In addition, the skull-constrained registration, employed in brain masking by standard space, affects the brain extraction. Though these errors have less impact on volumetric change results due to the integration across brain, this distortion can cause considerable errors in the edge flow image and the voxel-wise analysis of the local changes.

2.3 Neuroimaging Data

Three MRI datasets were used in this study. First, a synthetic dataset was made on the basis of the standard MNI templates of skull and brain. The MNI152 brain and skull templates of T1-W sequence were used with 1×1×1 mm resolution and 182×218×182 voxels. This dataset included the MNI152 brain template shifted in inferior-to-superior (Z), posterior-to-anterior (Y), or both (YZ) directions by different shift values in the range of (−5 mm, +5 mm) by 0.2 mm steps. The shifting is a simulation for change in the intracranial brain position so as to evaluate the performance of pair registration algorithm of FSL-PAIRREG. Regarding the skull image, the same MNI skull template was considered for all shifted brain images.

The second dataset, included T1-W MR images of eight healthy volunteers who underwent long-term bed rest at the NASA Flight Analogs Facility at the University of Texas Medical Branch, Galveston, as part of a multi-investigator study [47]. Throughout the head-down tilt bed rest (HTBR) portion of the study, the subjects' beds were placed in a 6° Trendelenburg position. Our analysis is conducted on two brain MR imaging structural scans which were acquired at the first and the last day of the bed rest experiment respectively (see Table 1 for demographic information).

TABLE 1
Demographic information of the participants in
two HTBR and normal aging cohorts (mean ± std).

| Cohort | HTBR | Aging |
|---|---|---|
| Participants | 8 (5 Male) | 24 (5 Male) |
| Age [Year] | 33.0 ± 7.4 | 49.3 ± 2.4 |
| Time between scans | 53.5 ± 7.5 Day | 2.8 ± 1.5 Year |

The structural MR images consisted of T1-weighted 3D echospoiled gradient-echo images acquired on a 1.5 T scanner (GE Healthcare, Milwaukee, Wis.). Images were acquired in either transverse or coronal planes, at either 1.0- or 1.5-mm section thickness with FOVs of 250 or 260 mm. Scanning parameters were TR=22 ms, TE=8 ms, flip angle=30°, and matrix=256×256 [46]. The other cohort included 24 healthy participants (aging group) who had undergone MRI using T1-W sequence at two points in time (see Table 1) using Siemens Sonata 1.5 T and Trio 3 T scanners at voxel size 1×1×1.25 mm³ with 256×256×128 image size. These MRI data, acquired in the Washington University in Saint Louis through the dominantly inherited Alzheimer network (DIAN) study [48], were selected from the whole neuroimaging data for the ages between 45-55 years so as to study the brain structures over the healthy aging [48][49].

2.4 Implementation of Algorithms

To calculate global change (linear affine transformation matrix from Pre- to Post-brain) as well as total change (i.e. edge flow image), the proposed SB method was implemented using FSL tools as previously described in the subsection 2.1. The registration of skulls was carried out using FSL-FLIRT by weighting the cranium over skull base since the latter cannot precisely be labeled by automatic skull stripping [50, 51]. For total change analysis, the FSLSIENA script was modified such as it gets the brain segment as input rather than the whole head scan image. This was considered to exclude the errors due to brain extraction or skull stripping from total change analysis and to better compare between the proposed skull-based algorithm (SB) and the original FSL skull-constrained pair registration (PR). The global change parameters were extracted from the transformation matrices using MATLAB (version 9.4 R2018a, Mathworks Inc). We used IBM SPSS (version 25) for statistical analysis of results. However, the statistical inference on flow images across each (aging and HTBR) cohort was performed using the FSL-Randomise non-parametric permutation tool [52], with 5000 permutations and the time interval between scans as a covariate.

### 3 RESULTS AND DISCUSSION

3.1 Evaluation by Synthetic Data

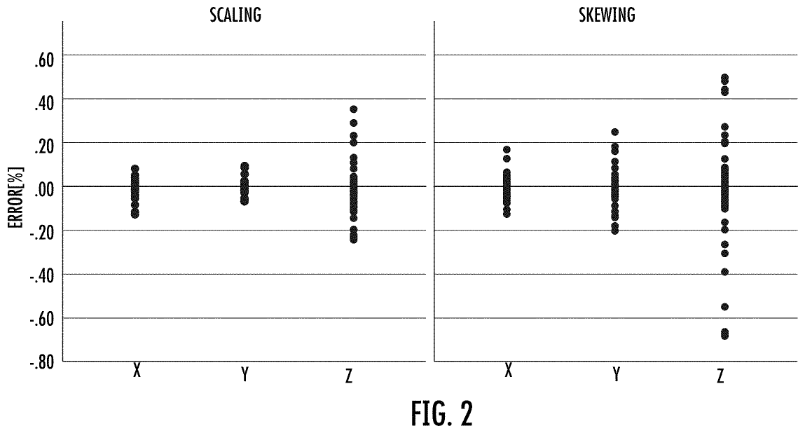

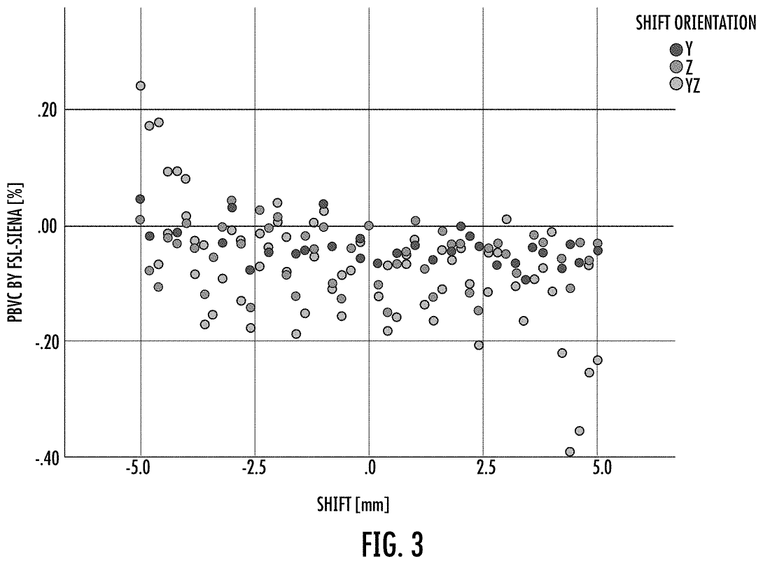

The skull-constrained pair registration, FSLPAIRREG, is used in FSL-SIENA(X) for aligning the extracted skulls of two MRI scans taken from the same subject at two points in time (or onto MNI template). This registration method was applied to the synthetic data, consisting of MNI152 standard brain template at 1 mm resolution and it's shifted version on either superior (Z), anterior (Y) or both directions (YZ). The same skull template was used for both time points. So, we ideally expected no morphological change from the registration step. FIG. 2 shows the errors in scaling and skewing parameters due to skull-constrained pair registration (PR) provided by the FSL package. The proposed SB algorithm naturally led to an accurate alignment without any error because the brains were exactly the same except for a shift. It turns out that the registration error is more sensitive to shifting in Z direction than in Y direction (see FIG. 2). A synergistic increase in error was observed in the YZ case that can potentially exacerbate much more for practical data (see FIG. 3). The misregistering of FSL-PAIRREG algorithm leads to erroneous PBVC values as shown in FIG. 3. Ideally, the PBVC value for this synthetic data should be zero. This PBVC error is due to either skull-constrained pair registration or the interpolation error of the synthetic data. FIG. 3 shows the synergistic effect of shifting (YZ versus Y or Z alone) on the PBVC error. The PBVC error remains low because of volumetric integration across brain.

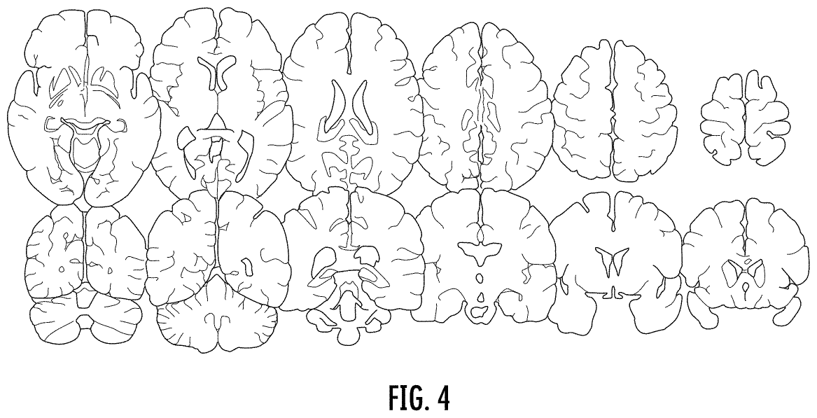

Furthermore, this pair registration error will impose on the local change (e.g. edge flow image) with a spatially varying pattern due to the scaling and skewing operations. The further the voxels are away from the coordinate center; the larger error in the local change results will appear. In other words, the PR registration causes a considerable displacement error at the outer cortices (an approximate cerebral size of 20 cm and scaling error of 0.2% results in about 0.4 mm shift). Then, this registration error will be remarkable on the edge flow image. FIG. 4 demonstrates the errors on the edge flow image for one series of synthetic data: posterior shift of Y=−5 mm. The FSL-SIENA demonstrates regression of cerebrum at the posterior cortices as well as posterior aspects of lateral ventricles to compensate for this posterior shift.

3.2 Analysis of the HTBR and Normal Aging Groups

Global Linear Change

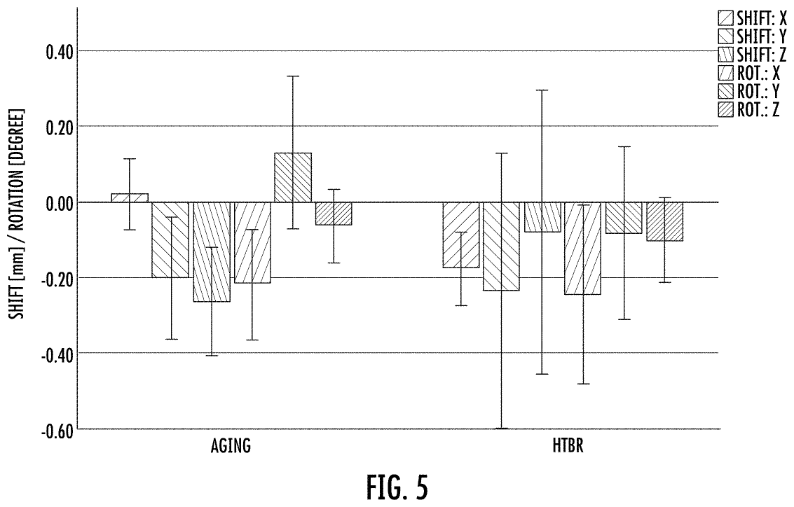

The MRI data of HTBR and normal aging groups were considered for implementing the proposed methodology so as to estimate the global linear change. Global changes are estimated from an affine transformation matrix as described in subsection 2.1. Based on nonparametric One-Sample Wilcoxon Signed Rank Test, some global change parameters were significant as shown in FIG. 5. The normal aging group exhibited significant shifts of −0.20 mm, p=0.02 and −0.26 mm, p<0.001 in the brain position along Y (posterior to anterior) and Z (inferior to superior) directions respectively, in addition to a rotation of −0.22°, p=0.01 around X (left-to-right axis) (see FIG. 5). The normal aging results in a significant global shrinkage of brain over all 3 axes with average scaling of −0.5%, p<0.01. However, the HTBR group exhibited an asymmetric shift along the X (left to right) axis equal to −0.18 mm, p=0.02. The global linear compression of brain turns out to be larger in the HTBR group (scaling factor of −0.8%, p=0.01). Importantly, the brain is shrinking along X and Y axes in the HTBR group compared with a uniform shrinkage of brain over all three axes in the normal aging group.

Volumetric Analysis

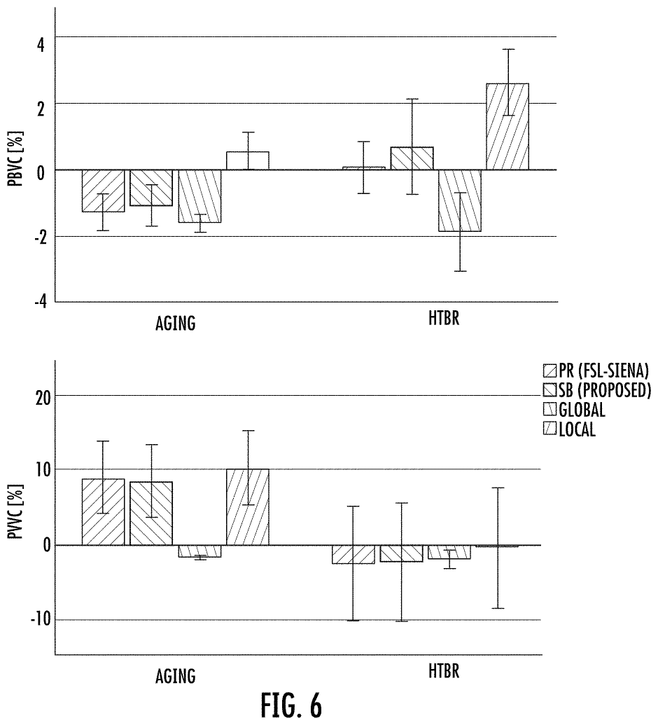

Volumetric analyses were performed on the HTBR and normative aging groups to estimate the total volumetric change with PBVC and percentage ventricular volume change (PVVC) parameters. Two conventional FSL-SIENA (method PR) and proposed SB method have been used. The proposed SB method has nevertheless described the total volumetric change with two global and local components as well (see FIG. 6).

The annual PBVC for normal control group was obtained as −0.59%, p<0.001 by the conventional PR method compared with −0.44%, p=0.01 by the proposed SB method (see FIG. 6). Previous studies have predicted an annual atrophy rate of approximately −0.5% [2, 3, 53] for healthy aging. The PR and SB methods lead to the annual PVVC rates of +2.85% (p=0.002) and +2.68% (p=0.002) respectively. In addition, there is a considerable difference on the individual PBVC rates estimated by the PR and SB methods though their averages are nearly the same. It was previously shown that the estimation error of the conventional PR method gets larger as we move away from the center coordinate due to the spatially-varying errors of scaling factor. So, the misregistration of the conventional PR method gets smaller in the PVVC. The proposed SB method provides with useful extra information on the local and global volumetric changes as well. Importantly, the normative aging group exhibits a global compression combined with a local extension across brain for both PBVC and PVVC rates (see FIG. 6). However, the global shrinkage and local extension are respectively dominant in the PBVC and PVVC. In other words, the brain is totally shrinking due to global linear compression. When it comes to the PVVC, the ventricular system shows a local enlargement being greater than its global compression. So, the total PVVC takes on a significant positive value (i.e. enlargement) in the normal aging group.

Considering the HTBR group, both the PR and SB methods exhibit no significant change in the total PBVC and PVVC rates. However, the proposed SB method provides with some intuitive information on the change components. Based on the proposed SB method, both the brain and the ventricular systems show a significant global shrinkage −1.9% (p=0.02). The local enlargement compensates for this global shrinkage yielding no significant change in the total PBVC and PWC. However, the local enlargement is significant in the PBVC case, even larger than the local PBVC change in the aging group.

Overall, both the healthy aging (over about 3 years) group shows a negative PBVC along with a positive PVVC. In contrast, the HTBR group (bedrest over about 2 months) is represented with no significant change in the PBVC and PVVC. The results show that the healthy aging causes a progressive local enlargement of the ventricular system over time. The bed rest experience over only 2 months appears to be missing this local enlargement in the ventricular system.

Based on the proposed SB method, we can report that there are two reverse scenarios through brain volumetric changes. Brain tissue volume decreases globally (SB-Global) but increases locally (SB-Local) (see FIG. 6). We can hypothesize that the global shrinkage of the brain tissue is originated from the mechanical forces due to the CSF hydrodynamics since it is unlikely that neuronal changes are synchronized across the entire brain (as global change implies the same change across the whole brain). In contrast, the local changes in brain tissue turn out to be more related to the neuronal phenomena such as metabolism and vascular mechanisms.

According to the FIG. 6, we may deduce that the different mechanisms govern on the ventricular volume change between the normative aging and bed rest processes (e.g. mechanical versus neuronal causes). In the bed rest experiment, the global PVVC remains dominant. This may be related to the mechanical CSF forces (CSF pressure-volume model) that have much faster dynamics than neuronal aging. This difference in the mechanisms is more evident in the voxel-wise analysis that follows.

Voxel-Wise Analysis

Using the flow image analysis developed in the FSL-SIENA, we can quantify the atrophy spread across the brain. The edge flow images show the perpendicular edge motion across the entire brain surface. The edge displacement or local atrophy is calculated in mm. To pool the atrophy results across subjects, the flow images were warped to align with a standard space edge image and then we carried out a voxel-wise cross-subject statistical analysis to identify brain edge points which, for example, are significantly atrophic for the group of subjects as a whole (i.e. here healthy aging or HTBR groups). The statistical analysis was implemented using FSL-RANDOMIZE tool for non-parametric permutation inference on neuroimaging data [52]. We considered threshold-free cluster enhancement (TFCE) as the test statistic and 5000 permutations were employed for each group by randomly selecting the permutations (i.e. Monte Carlo method across all possible permutations). The estimation of the variance that was fed to the final “t” statistic image was improved by spatially smoothing the results using a Gaussian filter kernel with full width half magnitude (FWHM) of 6 mm. Linear regression examining the effects of bed rest experiment and aging on the local brain changes (edge flow images) was carried out with the time interval between scans as covariate for respectively the HTBR and normal aging cohorts. This covariate represents the bed rest experimental duration and the aging time interval for the HTBR and the control groups respectively.

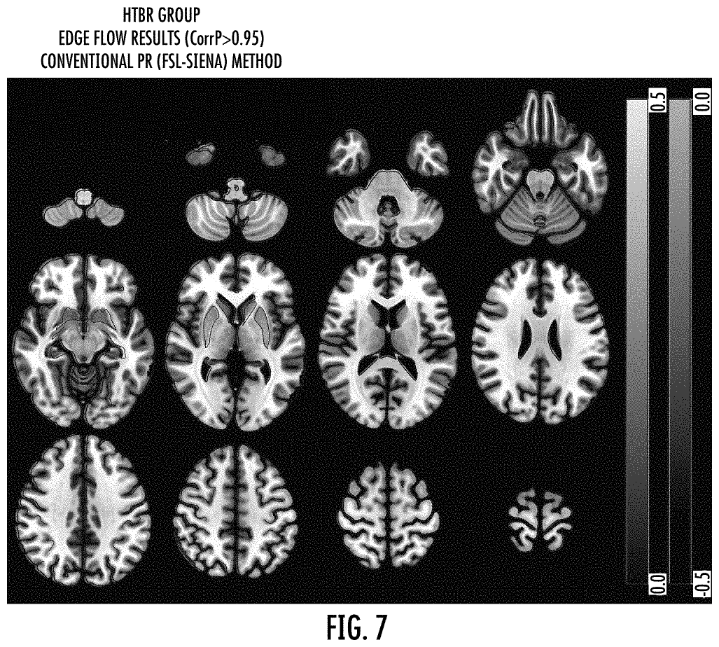

FIG. 7 shows the voxels with significant edge displacement for the HTBR group using the conventional PR adjusted for the bed rest duration. The proposed SB method showed no significant edge displacement. The conventional PR method spotted a small atrophy region on the left temporal lobe as well as an extension area at the inferior prefrontal cortex (specifically on right prefrontal). No associated observation has been reported for people involved in the bed rest (or microgravity analog) experiments, neither in the astronauts following a long exposure to microgravity. The proposed SB method shows no significant atrophy or extension in the voxel-wise analysis of the HTBR group. This is consistent with the volumetric results (see FIG. 6) in which both the PR and SB methods demonstrated that the PBVC and PVVC are insignificant in the HTBR group. The voxel-wise results of the conventional PR method can be related to the global linear changes, especially an asymmetric shift (−0.18 mm) from right-to-left, that we found for the HTBR group (see previous subsection).

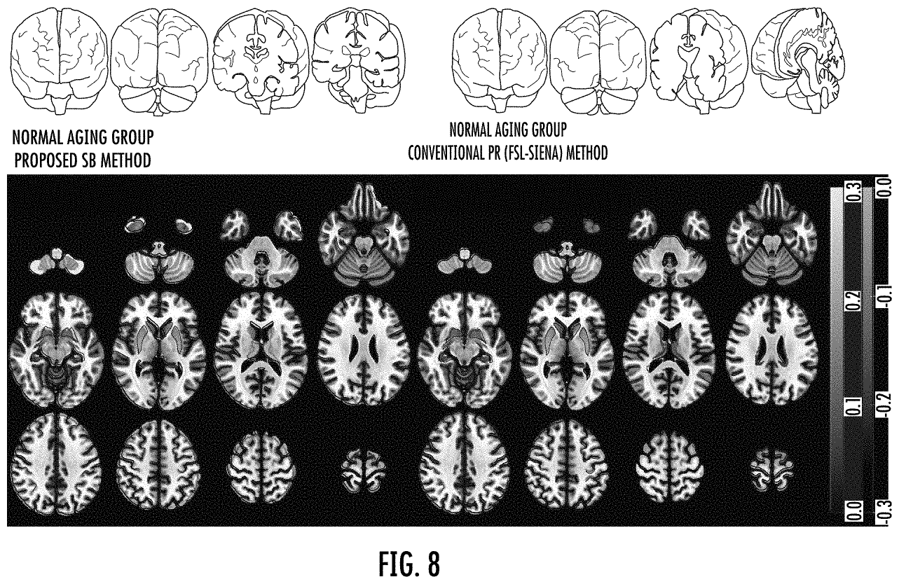

The permutation analysis on the normal aging group came out with the results as shown in FIG. 8 with adjusting for the time interval between scans. The conventional PR method demonstrated an atrophy state all around the superior frontal lobes and around the lateral ventricles. The largest atrophy occurs around the inter-junction of left caudate and left thalamus. However, the proposed SB method identifies regions with atrophy and extension. The SB method demonstrates a regression or atrophy on the superior portion of the brain around vertex. The atrophy regression is also spotted on the superior thalamus, inferior to the ventricular system. An extension or edema is also localized at the inferior temporal and frontal lobes (see FIG. 8). Since we found that brains undergo shifts from superior-to-inferior and from anterior-to-posterior over aging as global linear changes, these shifts are associated with displacements in the brain boundaries: regression on superior and extension at the inferior aspects. Then, the results of the proposed SB method reasonably account for these global changes. The difference between the conventional PR and the proposed SB methods are pronounced in the voxel-based analysis compared to the volumetric analysis. This is normally expected as the volumetric parameters are less susceptible to the misregistration errors because of the integration across the whole brain.

### 4. CONCLUSIONS

We demonstrated both mathematically and experimentally that the conventional PR method, used in the longitudinal (SIENA) and cross-sectional (SIENAX) studies, leads to specifically inaccurate analysis of local deformation if there is a shifting or rotational change in the brain positioning between two MRI scans. In practice, those global changes in the position of the brain are generating local morphological errors through the PR algorithm. Like the proposed skull-based algorithm (SB), it is necessary to utilize complete spatial information from voxels representing the skulls so as to avoid that misalignment error occurring in the PR method. In addition, we suggest that longitudinal changes to be characterized through two complementary volumetric parameters: global linear changes and local deformations. These two parameters can be combined to calculate the total volumetric change in the brain. The decomposition of volumetric change into the proposed two volumetric components (global linear change and local change) has a potential to provide with a deeper insight on the analysis of brain changes. The global changes obey the same profile across the entire brain. So, the global changes may correspond to some mechanism distributed all across brain such as the CSF hydrodynamics. In contrast, the local deformations in the brain are more due to different neuronal mechanisms such as metabolism.

Considering two time-point head MRI scans of healthy subjects in the bed rest HTBR (right before and after the bedrest experimentation during about 53.5 days) and normal aging groups (over a time interval of approximately 2.8 years), the implementation of the proposed SB method shows that the brain undergoes significant global changes (shift, rotation and compression). We hypothesize that these global changes are due to the hydrodynamics of the CSF distribution as the global change is in concert across the whole brain.

The conventional PR and the proposed SB methods led to approximately comparable results in terms of PVVC and PBVC for the normative aging group. As it was discussed previously, the errors due to the shifting and rotation get larger on the extra axial regions. So, the PVVC is less affected by the mis-registration error. Furthermore, the proposed idea of decomposing the structural changes into global and local changes has a potential to develop new biomarkers in studying various brain disorders. For example, the normative aging and HTBR group showed different local volumetric changes. Though, the HTBR group came up with no significant volumetric change, but they show a significant and larger local deformation component compared with the normative aging group. So, we can hypothesize that the normative aging process is mainly associated with the lack of local deformation component. It can be related to hardening of the brain tissue over aging. Finally, the results based on the comparison between the HTBR and normal aging groups should nevertheless be taken under consideration with caution because of few participants as well as the gender mismatch between two groups.

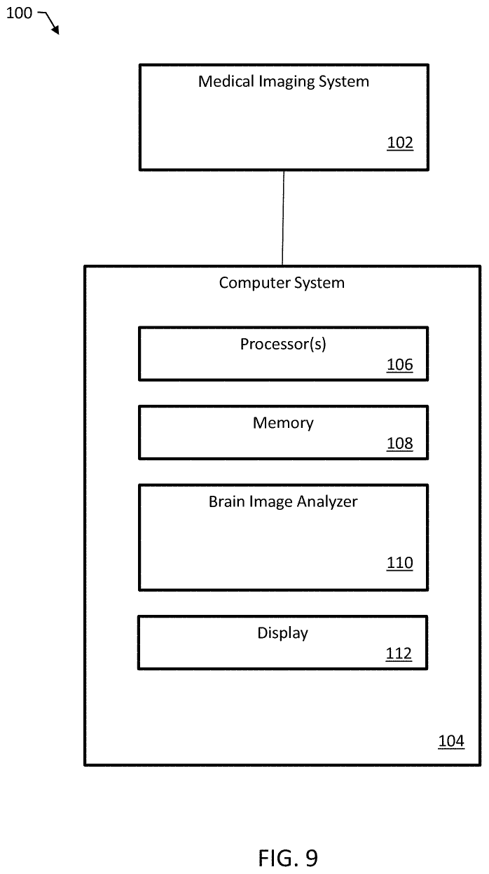

FIG. 9 is a block diagram of an example system 100 for determining changes in brain structure from brain images. The system 100 includes a medical imaging system 102 and a computer system 104.

The medical imaging system 102 can be any appropriate system for capturing brain images. For example, the medical imaging system 102 can be a magnetic resonance imaging (MRI) system. The medical imaging system 102 can communicate directly with the computer system 104, e.g., by transmitting brain images to the computer system 104, or indirectly with the computer system 104, e.g., by storing images locally or on another computer system for later processing on the computer system 104.

The computer system 104 includes one or more processors 106 and memory 108 storing executable instructions for the processors 106. The computer system 104 includes a brain image analyzer 110 implemented using the one or more processors. The computer system 104 includes a display device 112.

The brain image analyzer 110 is configured, by virtue of appropriate programming, for receiving a first brain image of a brain taken at a first time and a second brain image of the brain taken at a second time; characterizing a structural change of brain tissue of the brain between the first time and the second time; and outputting one or more parameters characterizing the structural change based on the global linear change of brain tissue and the local deformation of brain tissue. Characterizing the structural change includes determining a global linear change of brain tissue using the first brain image and the second brain image; and determining a local deformation of brain tissue using the first brain image, the second brain image, and the global linear change of brain tissue.

In some examples, determining the global linear change includes. determining an affine transformation matrix by which the brain at the first time and the brain at the second time can be linearly aligned together. In some examples, determining the global linear change includes skull stripping both the first brain image and the second brain image and registering a first skull from the first brain image to a second skull from the second brain image to compensate for any geometrical differences due to head positioning during brain imaging. In some examples, determining the global linear change includes registering both the first brain image and the second brain image to a brain template so that the global linear change is represented in a common coordinate space.

Determining the local deformation can include determining an edge flow image using the first brain image and the second brain image. Determining the local deformation can include determining the local deformation based on a half-way space between the first brain image and the second brain image. In some examples, the brain image analyzer 110 is configured for determining a total volumetric change of the brain based on the global linear change of brain tissue and the local deformation of brain tissue.

Outputting one or more parameters characterizing the structural change based on the global linear change of brain tissue and the local deformation of brain tissue can include displaying, on the display device 112, one or more of a shift, a rotation, a scaling, and a skewing parameter based on the global linear change of brain tissue and the local deformation of brain tissue. In some examples, the brain image analyzer 110 is configured for displaying, on the display device 112, an edge displacement image of the structural change of brain tissue based on the global linear change of brain tissue and the local deformation of brain tissue.

Accordingly, while the methods and systems have been described in reference to specific embodiments, features, and illustrative embodiments, it will be appreciated that the utility of the subject matter is not thus limited, but rather extends to and encompasses numerous other variations, modifications and alternative embodiments, as will suggest themselves to those of ordinary skill in the field of the present subject matter, based on the disclosure herein.

Various combinations and sub-combinations of the structures and features described herein are contemplated and will be apparent to a skilled person having knowledge of this disclosure. Any of the various features and elements as disclosed herein may be combined with one or more other disclosed features and elements unless indicated to the contrary herein. Correspondingly, the subject matter as hereinafter claimed is intended to be broadly construed and interpreted, as including all such variations, modifications and alternative embodiments, within its scope and including equivalents of the claims.

### REFERENCES

1. Leandrou, S., et al., Quantitative MRI Brain Studies in Mild Cognitive Impairment and Alzheimer's disease: A Methodological Review. IEEE Reviews in Biomedical Engineering, 2018.
2. Opfer, R., et al., Estimates of age-dependent cutoffs for pathological brain volume loss using SIENA/FSL—a longitudinal brain volumetry study in healthy adults. Neurobiology of aging, 2018. 65: p. 1-6.
3. Smith, S. M., et al., Longitudinal and cross-sectional analysis of atrophy in Alzheimer's disease: cross-validation of BSI, SIENA and SIENAX. Neuroimage, 2007. 36(4): p. 1200-1206.
4. De Stefano, N., et al., Voxel-level cross-subject statistical analysis of brain atrophy in early relapsing remitting MS patients. Int Soc Magn Reson Med (Book of Abstracts), 2003. 2: p. 2625.
5. Fox, N.C. and P. A. Freeborough, Brain atrophy progression measured from registered serial MRI: validation and application to Alzheimer's disease. Journal of Magnetic Resonance Imaging, 1997. 7(6): p. 1069-1075.
6. Reuter, M., et al., Head motion during MRI acquisition reduces gray matter volume and thickness estimates. Neuroimage, 2015. 107: p. 107-115.
7. Duning, T., et al., Dehydration confounds the assessment of brain atrophy. Neurology, 2005. 64(3): p. 548-550.
8. Dickson, J., et al., The effects of dehydration on brain volume—preliminary results. International journal of sports medicine, 2005. 26(06): p. 481-485.
9. Kempton, M. J., et al., Effects of acute dehydration on brain morphology in healthy humans. Human brain mapping, 2009. 30(1): p. 291-298.
10. Bartsch, A. J., et al., Manifestations of early brain recovery associated with abstinence from alcoholism. Brain, 2007. 130(1): p. 36-47.
11. Bruno, A., et al., A standardized method to measure brain shifts with decompressive hemicraniectomy. Journal of neuroscience methods, 2017. 280: p. 11-15.
12. Takao, H., N. Hayashi, and K. Ohtomo, Effect of scanner in longitudinal studies of brain volume changes. Journal of Magnetic Resonance Imaging, 2011. 34(2): p. 438-444.
13. Huff, T. and S. C. Dulebohn, Neuroanatomy, Cerebrospinal Fluid. 2017.
14. Coll, G. and J. Chazal, Anatomy and physiology of cerebrospinal fluid. European Annals of Otorhinolaryngology, Head and Neck Diseases, 2011. 128(6): p. 309-316.
15. Leyden, E., Beiträge und Untersuchungen zur Physiologie und Pathologie des Gehirns. Archiv für pathologische Anatomie und Physiologie und für klinische Medicin, 1866. 37(4): p. 519-559.
16. Janny, P., La surveillance de la pression intra-cranienne en neuro-chirurgie. Neurochirurgie, 1974. 20(6): p. 521-550.
17. Nornes, H., R. Aaslid, and K.-F. Lindegaard, Intracranial pulse pressure dynamics in patients with intracranial hypertension. Acta neurochirurgica, 1977. 38(3-4): p. 177-186.
18. Kelly, P. J., et al., Computer-assisted stereotaxic laser resection of intra-axial brain neoplasms. Journal of neurosurgery, 1986. 64(3): p. 427-439.
19. Gerard, I. J., et al., Brain shift in neuronavigation of brain tumors: A review. Medical image analysis, 2017. 35: p. 403-420.
20. Bayer, S., et al., Preliminary Study Investigating Brain Shift Compensation using 3D CBCT Cerebral Vascular Images, in Bildverarbeitung für die Medizin 2018. 2018, Springer. p. 163-168.
21. Vahedi, K., et al., Sequential-design, multicenter, randomized, controlled trial of early decompressive craniectomy in malignant middle cerebral artery infarction (DECIMAL Trial). Stroke, 2007. 38(9): p. 2506-2517.
22. Morandi, X., et al., Brain shift is central to the pathogenesis of intracerebral haemorrhage remote from the site of the initial neurosurgical procedure. Medical hypotheses, 2006. 67(4): p. 856-859.
23. Tsutsumi, S., H. Ono, and Y. Yasumoto, Immobile cerebral veins in the context of positional brain shift: an undescribed risk factor for acute subdural hemorrhage. Surgical and Radiologic Anatomy, 2017. 39(10): p. 1063-1067.
24. Feng, Y., et al., Relative brain displacement and deformation during constrained mild frontal head impact. Journal of the Royal Society Interface, 2010. 7(53): p. 1677-1688.
25. Baumgartner, L. and K. U. Schmitt, Computer simulations to investigate the consequence of blunt head impact. Journal of forensic sciences, 2014. 59(5): p. 1191-1197.
26. Monea, A. G., et al., Assessment of Relative Brain-Skull Motion in Quasistatic Circumstances by Magnetic Resonance Imaging. Journal of Neurotrauma, 2012. 29(3): p. 2305-2317.
27. Rinder, L. and Y. Olsson, Studies on vascular permeability changes in experimental brain concussion. Acta neuropathologica, 1968. 11(3): p. 201-209.
28. Olsson, Y., et al., Studies on vascular permeability changes in experimental brain concussion. Acta neuropathologica, 1971. 19(3): p. 225-233.
29. Govons, S. R., et al., Brain concussion in the rat. Experimental Neurology, 1972. 34(1): p. 121-128.
30. Choi, K. S., et al., Impact of brain shift on subcallosal cingulate deep brain stimulation. Brain Stimulation: Basic, Translational, and Clinical Research in Neuromodulation, 2018. 11(2): p. 445-453.
31. Roberts, D. R., et al., Effects of Spaceflight on Astronaut Brain Structure as Indicated on MRI. New England Journal of Medicine, 2017. 377(18): p. 1746-1753.
32. Miller, D. H., et al., Measurement of atrophy in multiple sclerosis: pathological basis, methodological aspects and clinical relevance. Brain, 2002. 125(8): p. 1676-1695.
33. Freeborough, P. A. and N. C. Fox, The boundary shift integral: an accurate and robust measure of cerebral volume changes from registered repeat MRI. IEEE transactions on medical imaging, 1997. 16(5): p. 623-629.
34. Smith, S. M., et al., Normalized accurate measurement of longitudinal brain change. Journal of computer assisted tomography, 2001. 25(3): p. 466-475.
35. Smith, S. M., et al., Accurate, robust, and automated longitudinal and cross-sectional brain change analysis. Neuroimage, 2002. 17(1): p. 479-489.
36. de Bresser, J., et al., A comparison of MR based segmentation methods for measuring brain atrophy progression. Neuroimage, 2011. 54(2): p. 760-768.
37. Guo, J., et al., Brain structural changes in women and men during midlife. Neuroscience letters, 2016. 615: p. 107-112.
38. Farzan, A., et al., Boosting diagnosis accuracy of Alzheimer's disease using high dimensional recognition of longitudinal brain atrophy patterns. Behavioural brain research, 2015. 290: p. 124-130.
39. Mak, E., et al., Longitudinal assessment of global and regional atrophy rates in Alzheimer's disease and dementia with Lewy bodies. NeuroImage: Clinical, 2015. 7: p. 456-462.
40. De Stefano, N., et al., Assessing brain atrophy rates in a large population of untreated multiple sclerosis subtypes. Neurology, 2010. 74(23): p. 1868-1876.
41. De Stefano, N., et al., Establishing pathological cut-offs of brain atrophy rates in multiple sclerosis. J Neurol Neurosurg Psychiatry, 2015: p. jnnp-2014-309903.
42. Takao, H., N. Hayashi, and K. Ohtomo, A longitudinal study of brain volume changes in normal aging. European journal of radiology, 2012. 81(10): p. 2801-2804.
43. Cassady, K., et al., Effects of a spaceflight analog environment on brain connectivity and behavior. NeuroImage, 2016. 141: p. 18-30.
44. Li, K., et al., Effect of Simulated Microgravity on Human Brain GrayMatter and WhiteMatter—Evidence from MRI. Plos One, Aug. 13, 2015: p. 1-10.
45. Carvil, P., R. Baptista, and T. Russomano, The human body in a microgravity environment: long term adaptations and countermeasures. Aviation in Focus, January-July 2013. 4(1): p. 10-22.
46. Roberts, D. R., et al., Structural Brain Changes following Long—Term 6° Head-Down Tilt Bed Rest as an Analog for Spaceflight. American Journal of NeuroRadiology, 2015: p. 1-7.
47. Meck, J. V., S. A. Dreyer, and L. E. Warren, Long-duration head—down bed rest: project overview, vital signs, and fluid balance. Aviation, Space, and Environmental Medicine, 2009. 80(5): p. A1-A8.
48. Morris, J. C., et al., Developing an international network for Alzheimer research: the Dominantly Inherited Alzheimer Network. Clinical investigation, 2012. 2(10): p. 975.
49. Cash, D. M., et al., The pattern of atrophy in familial Alzheimer disease volumetric MRI results from the DIAN study. Neurology, 2013. 81(16): p. 1425-1433.
50. Jenkinson, M., Improved unwarping of EPI images using regularised B0 maps. NeuroImage, 2001. 13(6): p. 165.
51. Jenkinson, M., et al., Improved optimization for the robust and accurate linear registration and motion correction of brain images. Neuroimage, 2002. 17(2): p. 825-841.
52. Winkler, A. M., et al., Permutation inference for the general linear model. Neuroimage, 2014. 92: p. 381-397.
53. Fjell, A. M., et al., Critical ages in the life course of the adult brain: nonlinear subcortical aging. Neurobiology of aging, 2013. 34(10): p. 2239-2247.
54. Yamasaki, S., et al., Reduced gray matter volume of pars opercularis is associated with impaired social communication in high—functioning autism spectrum disorders. Biological psychiatry, 2010. 68(12): p. 1141-1147.
55. Acton, Q. A., Issues in Clinical Psychology, Psychiatry, and Counseling: 2012 Edition, ed. Q. A. Acton. 2013, Atlanta, Ga.: ScholarlyEditions™.
56. Nelson, E. S., L. Mulugeta, and J. G. Myers, Microgravity-induced fluid shift and ophthalmic changes. Life, 2014. 4(4): p. 621-665.
57. Mader, T. H., et al., Optic disc edema in an astronaut after repeat long-duration space flight. Journal of Neuro-Ophthalmology, 2013. 33(3): p. 249-255.

What is claimed is:

1. A method for determining changes in brain structure from brain images, the system comprising:
receiving, at a brain image analyzer implemented on a computer system comprising one or more processors, a first brain image of a brain taken at a first time and a second brain image of the brain taken at a second time;
characterizing, at the brain image analyzer, a structural change of brain tissue of the brain between the first time and the second time by:
determining a global linear change of brain tissue using the first brain image and the second brain image; and
determining a local deformation of brain tissue using the first brain image, the second brain image, and the global linear change of brain tissue; and
outputting, from the brain image analyzer, one or more parameters characterizing the structural change based on the global linear change of brain tissue and the local deformation of brain tissue.

2. The method of claim 1, wherein determining the global linear change comprises determining an affine transformation matrix by which the brain at the first time and the brain at the second time can be linearly aligned together.

3. The method of claim 1, wherein determining the global linear change comprises skull stripping both the first brain image and the second brain image and registering a first skull from the first brain image to a second skull from the second brain image to compensate for any geometrical differences due to head positioning during brain imaging.

4. The method of claim 1, wherein determining the global linear change comprises registering both the first brain image and the second brain image to a brain template so that the global linear change is represented in a common coordinate space.

5. The method of claim 1, wherein determining the local deformation comprises determining an edge flow image using the first brain image and the second brain image.

6. The method of claim 1, wherein determining the local deformation comprises determining the local deformation based on a half-way space between the first brain image and the second brain image.

7. The method of claim 1, comprising determining a total volumetric change of the brain based on the global linear change of brain tissue and the local deformation of brain tissue.

8. The method of claim 1, wherein receiving the first brain image and the second brain image comprises receiving the first brain image and the second brain image as magnetic resonance imaging (MRI) images.

9. The method of claim 1, wherein outputting one or more parameters characterizing the structural change based on the global linear change of brain tissue and the local deformation of brain tissue comprises displaying, on a display device, one or more of a shift, a rotation, a scaling, and a skewing parameter based on the global linear change of brain tissue and the local deformation of brain tissue.

10. The method of claim 1, comprising displaying, on a display device, an edge displacement image of the structural change of brain tissue based on the global linear change of brain tissue and the local deformation of brain tissue.

11. A system for determining changes in brain structure from brain images, the system comprising:
one or more processors and memory storing executable instructions for the one or more processors; and
a brain image analyzer implemented using the one or more processors, wherein the brain image analyzer is configured for:
receiving a first brain image of a brain taken at a first time and a second brain image of the brain taken at a second time;
characterizing a structural change of brain tissue of the brain between the first time and the second time by:
determining a global linear change of brain tissue using the first brain image and the second brain image; and
determining a local deformation of brain tissue using the first brain image, the second brain image, and the global linear change of brain tissue; and
outputting one or more parameters characterizing the structural change based on the global linear change of brain tissue and the local deformation of brain tissue.

12. The system of claim 11, wherein determining the global linear change comprises determining an affine transformation matrix by which the brain at the first time and the brain at the second time can be linearly aligned together.

13. The system of claim 11, wherein determining the global linear change comprises skull stripping both the first brain image and the second brain image and registering a first skull from the first brain image to a second skull from the second brain image to compensate for any geometrical differences due to head positioning during brain imaging.

14. The system of claim 11, wherein determining the global linear change comprises registering both the first brain image and the second brain image to a brain template so that the global linear change is represented in a common coordinate space.

15. The system of claim 11, wherein determining the local deformation comprises determining an edge flow image using the first brain image and the second brain image.

16. The system of claim 11, wherein determining the local deformation comprises determining the local deformation based on a half-way space between the first brain image and the second brain image.

17. The system of claim 11, wherein the brain image analyzer is configured for determining a total volumetric change of the brain based on the global linear change of brain tissue and the local deformation of brain tissue.

18. The system of claim 11, wherein receiving the first brain image and the second brain image comprises receiving the first brain image and the second brain image as magnetic resonance imaging (MRI) images.

19. The system of claim 11, wherein outputting one or more parameters characterizing the structural change based on the global linear change of brain tissue and the local deformation of brain tissue comprises displaying, on a display device, one or more of a shift, a rotation, a scaling, and a skewing parameter based on the global linear change of brain tissue and the local deformation of brain tissue.

20. The system of claim 11, comprising a display device, wherein the brain image analyzer is configured for displaying, on the display device, an edge displacement image of the structural change of brain tissue based on the global linear change of brain tissue and the local deformation of brain tissue.
